(19) United States
(12) Patent Application Publication
(10) Pub. No.: US 2019/0073126 A1
(43) Pub. Date: Mar. 7, 2019

(54) MEMORY SYSTEM AND OPERATING METHOD OF THE SAME

(71) Applicant: SK hynix Inc., Gyeonggi-do (KR)

(72) Inventor: Jong-Min LEE, Seoul (KR)

(21) Appl. No.: 15/946,358

(22) Filed: Apr. 5, 2018

(30) Foreign Application Priority Data
Sep. 4, 2017 (KR) 10-2017-0112740

(51) Int. Cl. G06F 3/06

(52) U.S. Cl. CPC G06F 3/061; G06F 3/064; G06F 3/0679; G06F 3/0647; G06F 3/0658

(57) ABSTRACT

A memory system includes: a memory device that includes a plurality of memory blocks each of which includes a plurality of pages that store data; and a controller suitable for performing command executions corresponding to a plurality of commands received from a host on the memory blocks, checking first parameters for the memory blocks according to the command executions, selecting first memory blocks among the memory blocks based on the first parameters, performing a copy operation on the first memory blocks, checking second parameters for second memory blocks among the memory blocks, and selecting candidate memory blocks based on the second parameters.

### CROSS-REFERENCE TO RELATED APPLICATIONS

The present application claims priority to Korean Patent Application No. 10-2017-0112740, filed on Sep. 4, 2017, the disclosure of which is incorporated herein by reference in its entirety.

### BACKGROUND

### 1. Field

Exemplary embodiments of the present invention relate to a memory system capable of processing data with respect to a memory device, and an operating method thereof.

### 2. Description of the Related Art

The computer environment paradigm has changed to ubiquitous computing, which enables computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption since they have no moving parts. Examples of memory systems having such advantages include universal serial bus (USB) memory devices, memory cards having various interfaces, and solid state drives (SSD).

### SUMMARY

Various embodiments are directed to a memory system and an operating method thereof, capable of minimizing a complexity and a performance deterioration of a memory system and maximizing a use efficiency of a memory device, thereby quickly and stably processing data with respect to the memory device.

In accordance with an embodiment of the present invention, a memory system includes: a memory device that includes a plurality of memory blocks, each of which includes a plurality of pages that store data; and a controller suitable for performing command executions corresponding to a plurality of commands received from a host on the memory blocks, checking first parameters for the memory blocks according to the command executions, selecting first memory blocks among the memory blocks based on the first parameters, performing a copy operation on the first memory blocks, checking second parameters for second memory blocks among the memory blocks, and selecting candidate memory blocks based on the second parameters.

The controller may set a first threshold value for the copy operation and select the first memory blocks among the memory blocks by comparing the first parameters to the first threshold value.

The controller may detect a distribution degree of valid pages that are included in the memory blocks based on the first threshold value.

The controller may detect memory blocks having a locality distribution and memory blocks having a uniformity distribution among the memory blocks based on the first threshold value.

The controller may select the memory blocks having the uniformity distribution as the first memory blocks and select the memory blocks having the locality distribution as the second memory blocks.

The first memory blocks may be memory blocks for triggering the copy operation, and the second memory blocks may be memory blocks for skipping the copy operation.

The controller may set the first threshold value based on the number of third memory blocks among the memory blocks, the number of the first memory blocks, and the number of pages included in the third memory blocks.

The controller may set a second threshold value for at least one operation among a swap operation, the copy operation, and a bad block management operation on the second memory blocks, and select the candidate memory blocks by comparing the second parameters to the second threshold value.

The controller may select fourth memory blocks having a smallest first parameters are least parameters among the candidate memory blocks, and perform the copy operation on the fourth memory blocks.

The second parameters may be determined according to at least one operation among a swap operation, the copy operation, and a bad block management operation based on the first parameters.

In accordance with another embodiment of the present invention, a method for operating a memory system includes: receiving a plurality of commands from a host for a memory device that includes a plurality of memory blocks each of which includes a plurality of pages that store data; performing command executions corresponding to the commands onto the memory blocks; checking first parameters for the memory blocks according to the command executions; selecting first memory blocks among the memory blocks based on the first parameters; performing a copy operation on the first memory blocks; checking second parameters for second memory blocks among the memory blocks; and selecting candidate memory blocks based on the second parameters.

The selecting of the first memory blocks among the memory blocks based on the first parameters may include: setting a first threshold value for the copy operation on the memory blocks; and selecting the first memory blocks by comparing the first parameters to the first threshold value.

The selecting of the first memory blocks among the memory blocks based on the first parameters may further include: detecting a distribution degree of valid pages that are included in the memory blocks based on the first threshold value.

In the detecting of the distribution degree of the valid pages, memory blocks having a locality distribution and memory blocks having a uniformity distribution may be detected among the memory blocks based on the first threshold value.

The selecting of the first memory blocks among the memory blocks based on the first parameters may further include: selecting the memory blocks having the uniformity distribution as the first memory blocks; and selecting the memory blocks having the locality distribution as the second memory blocks.

The first memory blocks may be memory blocks for triggering the copy operation, and the second memory blocks may be memory blocks for skipping the copy operation.

In the setting of the first threshold value for the copy operation on the memory blocks, the first threshold value may be set based on the number of third memory blocks among the memory blocks, the number of the first memory blocks, and the number of pages included in the third memory blocks.

The selecting of the candidate memory blocks based on the second parameters may include: setting a second threshold value for at least one operation among a swap operation, the copy operation, and a bad block management operation on the second memory blocks; and selecting the candidate memory blocks by comparing the second parameters to the second threshold value.

The selecting of the candidate memory blocks based on the second parameters may further include: selecting fourth memory blocks having a smallest first parameters are least parameters among the candidate memory blocks; and performing the copy operation on the fourth memory blocks.

The second parameters may be determined according to at least one operation among a swap operation, the copy operation, and a bad block management operation based on the first parameters.

In accordance with another embodiment of the present invention, a method for operating a controller comprising: performing command executions corresponding to a plurality of commands received from a host on memory blocks; checking first parameters for the memory blocks according to the command executions to select first memory blocks among the memory blocks; performing a copy operation on the first memory blocks; and checking second parameters for second memory blocks among the memory blocks to select candidate memory blocks among the memory blocks.

In accordance with various embodiments of the present invention, complexity and performance degradation of a memory system may be minimized, use efficiency of the memory system may be maximized, and data for a memory device of the memory system may be promptly and stably processed.

### BRIEF DESCRIPTION OF THE DRAWINGS

These and other features and advantages of the present invention will become apparent to those skilled in the art to which the present invention pertains from the following detailed description in reference to the accompanying drawings.

FIG. 1 is a block diagram illustrating a data processing system including a memory system in accordance with an embodiment of the present invention.

FIG. 2 is a schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 1.

FIG. 4 is a block diagram illustrating an exemplary three-dimensional structure of the memory device shown in FIG. 2.

FIGS. 5 to 8 are schematic diagrams illustrating exemplary data processing operations corresponding to a plurality of commands in a memory system in accordance with an embodiment of the present invention.

FIG. 9 is a schematic flowchart describing a data processing operation in the memory system in accordance with an embodiment of the present invention.

FIGS. 10 to 18 are block diagrams schematically illustrating various data processing systems including the memory system in accordance with the embodiment of the present invention.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The drawings are not necessarily to scale and in some instances, proportions may have been exaggerated in order to clearly illustrate features of the embodiments. When a first layer is referred to as being “on” a second layer or “on” a substrate, it not only refers to a case where the first layer is formed directly on the second layer or the substrate but also a case where a third layer exists between the first layer and the second layer or the substrate.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

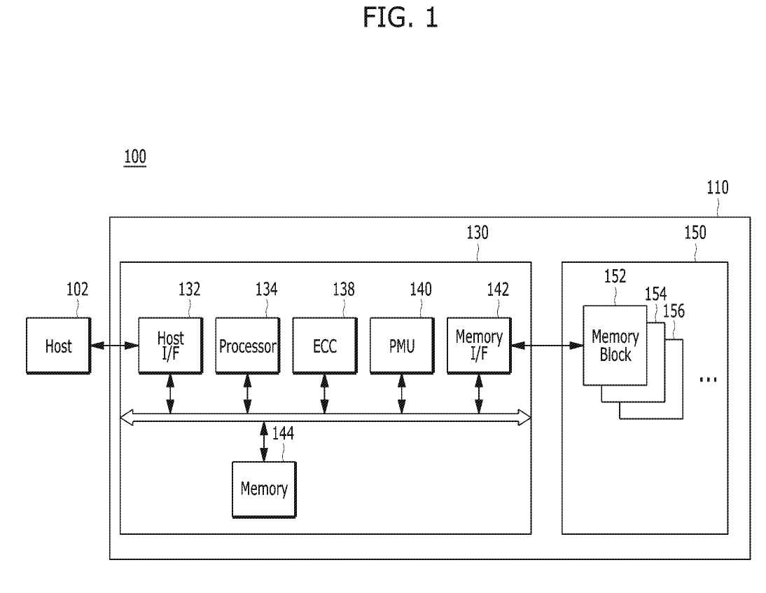

FIG. 1 is a block diagram illustrating a data processing system 100 including a memory system 110 in accordance with an embodiment of the present invention.

Referring to FIG. 1, the data processing system 100 may include a host 102 operatively coupled to the memory system 110.

The host 102 may include portable electronic devices such as a mobile phone, MP3 player and laptop computer or non-portable electronic devices such as a desktop computer, game machine, TV and projector.

The host 102 may include at least one OS (operating system), and the OS may manage and control overall functions and operations of the host 102, and provide an operation between the host 102 and a user using the data processing system 100 or the memory system 110. The OS may support functions and operations corresponding to the use purpose and usage of a user. For example, the OS may be divided into a general OS and a mobile OS, depending on the mobility of the host 102. The general OS may be divided into a personal OS and an enterprise OS, depending on the environment of a user. For example, the personal OS configured to support a function of providing a service to general users may include Windows and Chrome, and the enterprise OS configured to secure and support high performance may include Windows server, Linux and Unix. Furthermore, the mobile OS configured to support a function of providing a mobile service to users and a power saving function of a system may include Android, iOS and Windows Mobile. The host 102 may include a plurality of OSs, and may execute an OS to perform an operation corresponding to a user's request on the memory system 110. Here, the host 102 may provide a plurality of commands corresponding to a user's request to the memory system 110, and thus the memory system 110 may perform certain operations corresponding to the plurality of commands, that is, corresponding to the user's request.

The memory system 110 may store data for the host 102 in response to a request of the host 102. Non-limited examples of the memory system 110 may include a solid state drive (SSD), a multi-media card (MMC), a secure digital (SD) card, a universal storage bus (USB) device, a universal flash storage (UFS) device, a compact flash (CF) card, a smart media card (SMC), a personal computer memory card international association (PCMCIA) card and a memory stick. The MMC may include an embedded MMC (eMMC), reduced size MMC (RS-MMC) and micro-MMC. The SD card may include a mini-SD card and micro-SD card.

The memory system 110 may include various types of storage devices. Non-limited examples of storage devices included in the memory system 110 may include volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM), and a flash memory.

The memory system 110 may include a memory device 150 and a controller 130. The memory device 150 may store data for the host 102, and the controller 130 may control data storage into the memory device 150.

The controller 130 and the memory device 150 may be integrated into a single semiconductor device, which may be included in the various types of memory systems as exemplified above. For example, the controller 130 and the memory device 150 may be integrated as one semiconductor device to constitute an SSD. When the memory system 110 is used as an SSD, the operating speed of the host 102 connected to the memory system 110 can be improved. In another example, the controller 130 and the memory device 150 may be integrated as one semiconductor device to constitute a memory card. For example, the controller 130 and the memory device 150 may constitute a memory card such as a PCMCIA (personal computer memory card international association) card, CF card, SMC (smart media card), memory stick, MMC including RS-MMC and micro-MMC, SD card including mini-SD, micro-SD and SDHC, or UFS device.

Non-limited application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain stored data even though power is not supplied. The memory device 150 may store data provided from the host 102 through a write operation, and provide data stored therein to the host 102 through a read operation. In an embodiment, the memory device 150 may include a plurality of memory dies (not shown), each memory may include a plurality of planes (not shown), each plane may include a plurality of memory blocks 152 to 156, each of the memory blocks 152 to 156 may include a plurality of pages, and each of the pages may include a plurality of memory cells coupled to a word line. In an embodiment, the memory device 150 may be a flash memory having a 3-dimensional (3D) stack structure.

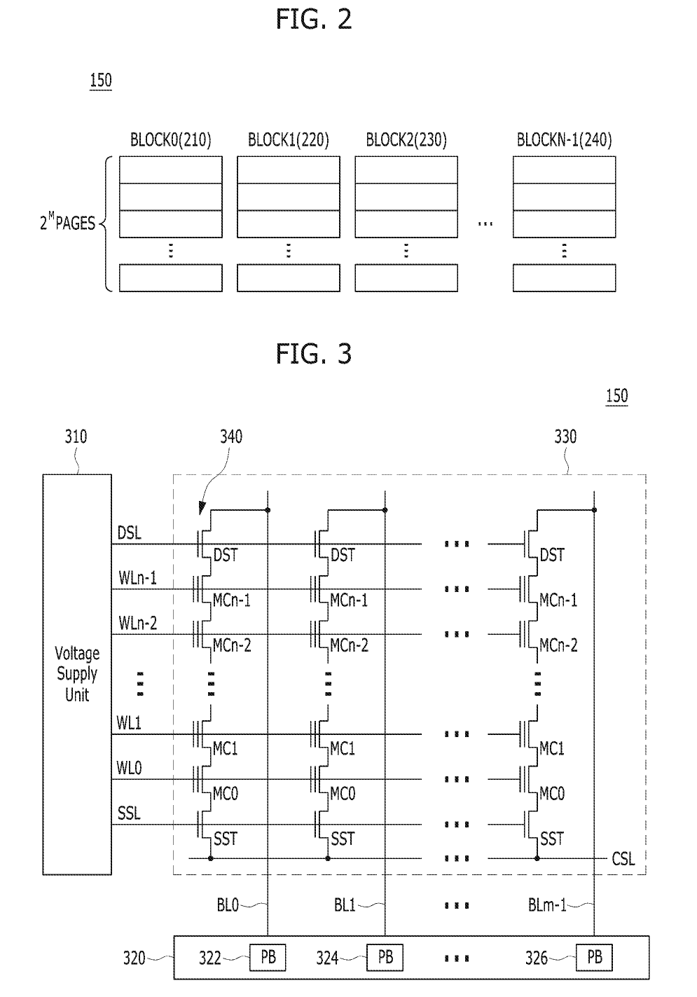

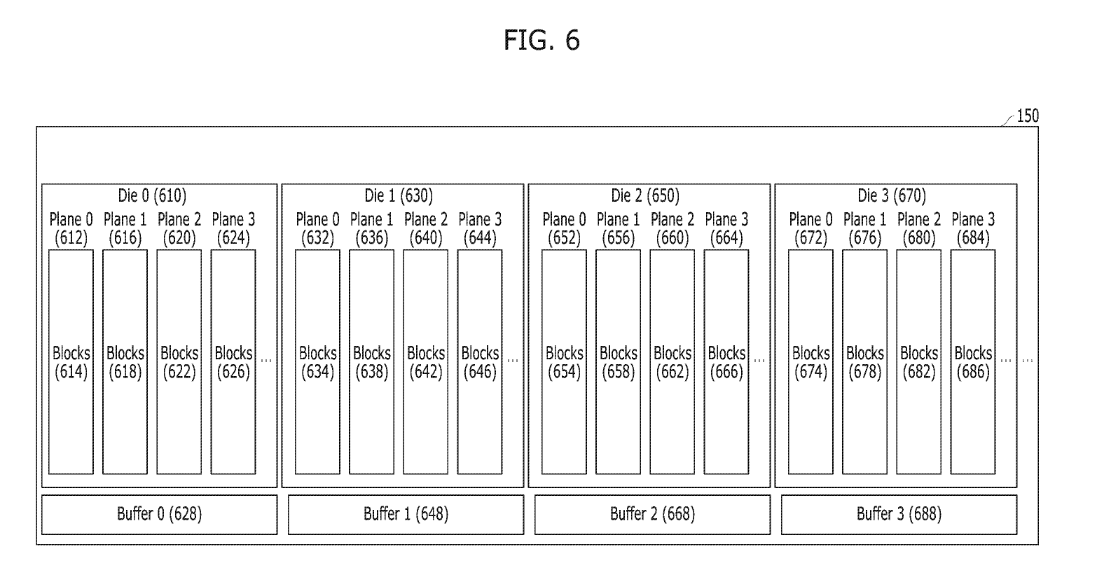

The structure of the memory device 150 and the 3D stack structure of the memory device 150 will be described in detail below with reference to FIGS. 2 to 4. The memory device 150 including a plurality of memory dies, each memory die including a plurality of planes, and each plane including a plurality of memory blocks 152 to 156 will be described in detail later with reference to FIG. 6. Accordingly, overlapping descriptions will be omitted herein.

The controller 130 may control the memory device 150 in response to a request from the host 102. More specifically, the controller may control a read operation, a write operation (also referred to as a program operation), and an erase operation of the memory device 150. For example, the controller 130 may provide data read from the memory device 150 to the host 102, and store data provided from the host 102 into the memory device 150.

The controller 130 may include a host interface (I/F) unit 132, a processor 134, an error correction code (ECC) unit 138, a Power Management Unit (PMU) 140, a memory interface unit 142, and a memory 144 all operatively coupled via an internal bus.

The host interface unit 132 may process a command and data of the host 102, and may communicate with the host 102 through one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATA), enhanced small disk interface (ESDI) and integrated drive electronics (IDE). The host interface unit 132 may be driven via a firmware, that is, a host interface layer (HIL) for exchanging data with the host 102.

Further, the ECC unit 138 may correct error bits of data to be processed by the memory device 150 and may include an ECC encoder and an ECC decoder. The ECC encoder may perform an error correction encoding on data to be programmed into the memory device 150 to generate data to which a parity bit is added. The data including the parity bit may be stored in the memory device 150. The ECC decoder may detect and correct an error contained in the data read from the memory device 150. In other words, the ECC unit 138 may perform an error correction decoding process to the data read from the memory device 150 through an ECC code used during an ECC encoding process. According to a result of the error correction decoding process, the ECC unit 138 may output a signal, for example, an error correction success/fail signal. When the number of error bits is more than a threshold value of correctable error bits, the ECC unit 138 may not correct the error bits, and may output an error correction fail signal.

The ECC unit 138 may perform error correction through a coded modulation such as Low Density Parity Check (LDPC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC unit 138 is not limited thereto. The ECC unit 138 may include all circuits, modules, systems or devices for error correction.

The PMU 140 may provide and manage power of the controller 130.

The memory interface unit 142 may serve as a memory/storage interface for interfacing the controller 130 and the memory device 150 such that the controller 130 may control the memory device 150 in response to a request from the host 102. When the memory device 150 is a flash memory or specifically a NAND flash memory, the memory interface unit 142 may be NAND flash controller (NFC) and may generate a control signal for the memory device 150 and process data to be provided to the memory device 150 under the control of the processor 134. The memory interface unit 142 may work as an interface (e.g., a NAND flash interface) for processing a command and data between the controller 130 and the memory device 150. Specifically, the memory interface unit 142 may support data transfer between the controller 130 and the memory device 150. The memory interface unit 142 may be driven via a firmware, that is, a flash interface layer (FIL) for exchanging data with the memory device 150.

The memory 144 may serve as a working memory of the memory system 110 and the controller 130, and store data for driving the memory system 110 and the controller 130. The controller 130 may control the memory device 150 to perform read, program, and erase operations in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be a volatile memory. For example, the memory 144 may be a static random access memory (SRAM) or dynamic random access memory (DRAM). The memory 144 may be disposed within or out of the controller 130. FIG. 1 exemplifies the memory 144 disposed within the controller 130. In an embodiment, the memory 144 may be an external volatile memory having a memory interface transferring data between the memory 144 and the controller 130.

As described above, the memory 144 may include a program memory, a data memory, a write buffer/cache, a read buffer/cache, a data buffer/cache and a map buffer/cache to store data required to perform data write and read operations between the host 102 and the memory device 150 and data required for the controller 130 and the memory device 150 to perform these operations.

The processor 134 may control the overall operations of the memory system 110. The processor 134 may drive firmware to control the overall operations of the memory system 110. The firmware may be referred to as flash translation layer (FTL).

For example, the controller 130 may perform an operation requested by the host 102 in the memory device 150 through the processor 134, which is implemented as a microprocessor, a CPU, or the like. In other words, the controller 130 may perform a command operation corresponding to a command received from the host 102. Herein, the controller 130 may perform a foreground operation as the command operation corresponding to the command received from the host 102. For example, the controller 130 may perform a program operation corresponding to a write command, a read operation corresponding to a read command, an erase operation corresponding to an erase command, and a parameter set operation corresponding to a set parameter command, or a set feature command as a set command.

Also, the controller 130 may perform a background operation on the memory device 150 through the processor 134, which is realized as a microprocessor or a CPU. Herein, the background operation performed on the memory device 150 may include an operation of copying and processing data stored in some memory blocks among the memory blocks 152 to 156 of the memory device 150 into other memory blocks, e.g., a garbage collection (GC) operation, an operation of performing swapping between the memory blocks 152 to 156 of the memory device 150 or between the data of the memory blocks 152 to 156, e.g., a wear-leveling (WL) operation, an operation of storing the map data stored in the controller 130 in the memory blocks 152 to 156 of the memory device 150, e.g., a map flush operation, or an operation of managing bad blocks of the memory device 150, e.g., a bad block management operation of detecting and processing bad blocks among the memory blocks 152 to 156 included in the memory device 150.

Also, in the memory system 110 in accordance with the embodiment of the present invention, the controller 130 may perform a plurality of command executions corresponding to a plurality of commands received from the host 102, e.g., a plurality of program operations corresponding to a plurality of write commands, a plurality of read operations corresponding to a plurality of read commands, and a plurality of erase operations corresponding to a plurality of erase commands, in the memory device 150. Also, the controller 130 may update meta-data, (particularly, map data) according to the command executions.

In particular, in the memory system in accordance with an embodiment of the present invention, when the controller 130 of the memory system 110 performs a plurality of command executions corresponding to a plurality of commands received from the host 102, e.g., program operations, read operations, and erase operations for a plurality memory blocks included in the memory device 150, there may occur a characteristics deterioration in the memory blocks due to the plurality of command executions and a decrement in a use efficiency of the memory device 150. Therefore, a copy operation or a swap operation may be performed in the memory device 150 in consideration of the parameters for the memory device 150 according to the command executions.

For example, in the memory system in accordance with an embodiment of the present invention, when the controller 130 performs program operations corresponding to a plurality of write commands received from the host 102 on the memory blocks included in the memory device 150, the controller 130 may perform a copy operation, e.g., a garbage collection operation, on the memory device 150 in order to improve the efficiency of the memory device 150 included in the memory system 110.

Also, in the memory system in accordance with an embodiment of the present invention, when the controller 130 performs erase operations corresponding to a plurality of erase commands received from the host 102 on the memory blocks included in the memory device 150, each of the memory blocks included in the memory device 150 may have an erase count limit, and accordingly, the controller 130 may perform erase operations corresponding to the erase commands within range of the erase count limit. For example, when the controller 130 performs erase operations in any particular memory blocks that are over an erase count limit, the particular memory blocks may be treated as bad blocks, which may no longer be usable. Herein, the erase count limit for the memory blocks of the memory device 150 may represent the maximum count to which the erase operations can be performed on the memory blocks of the memory device 150. Therefore, in the memory system in accordance with the embodiment of the present invention, the erase operations may be performed uniformly within the range of the erase count limit for the memory blocks of the memory device 150. Also, in order to secure an operation reliability for the memory blocks of the memory device 150 from the erase operations, a data processing the memory blocks of the memory device 150 may be performed in consideration of the parameters of the memory blocks of the memory device 150. For example, a swap operation, e.g., a wear-leveling operation, may be performed in the memory device 150.

Also, in the memory system in accordance with an embodiment of the present invention, when the controller 130 performs read operations corresponding to a plurality of read commands received from the host 102 on the memory blocks included in the memory device 150, a read disturbance due to the repetitive read operations may occur in the certain memory blocks, particularly, when the controller 130 repeatedly performs the read operations in some certain memory blocks. Therefore, the controller 130 may perform a read reclaim operation on the certain memory blocks to protect data loss of the certain memory blocks due to the read disturbance. In other words, in the memory system in accordance with the embodiment of the present invention, the controller 130 may perform a copy operation as a read reclaim operation of copying data stored in the certain memory blocks and store the copied data into other memory blocks in the memory device 150

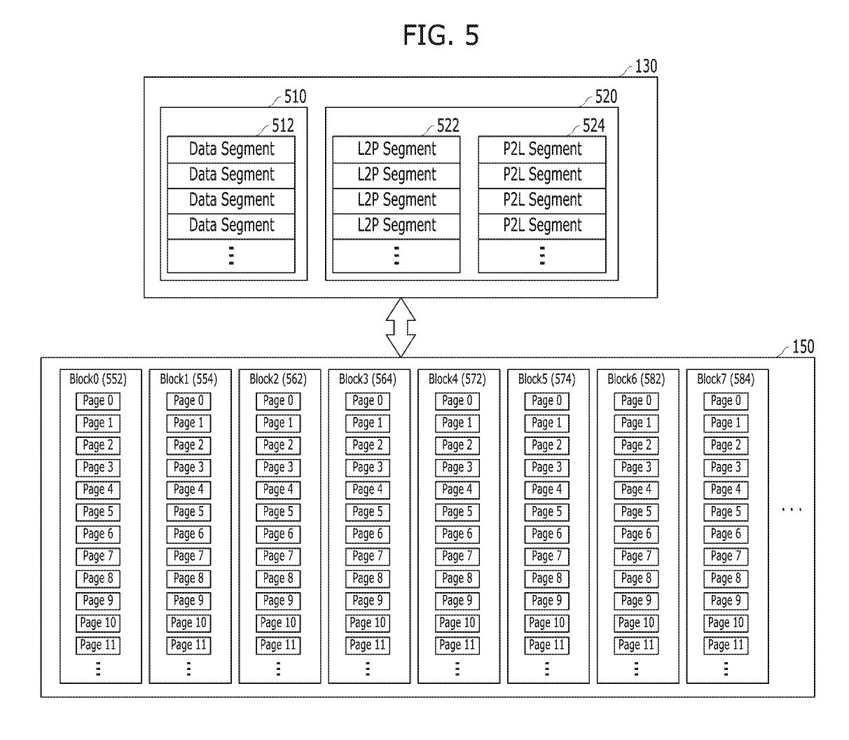

Herein, in the memory system in accordance with an embodiment of the present invention, the controller 130 may perform not only a swap operation and a copy operation but also a bad block management operation on some memory blocks in consideration of the parameters according to the command executions corresponding to the commands received from the host 102, e.g., valid page counts (VPC) of the memory blocks of the memory device 150 according to the program operations, erase counts according to the erase operations, program counts according to the program operations, and read counts according to the read operations. Also, in the memory system in accordance with an embodiment of the present invention, the controller 130 may perform a copy operation, e.g., a garbage collection operation, on the memory blocks of the memory device 150 in consideration of the parameters corresponding to not only the swap operation and the copy operation but also the bad block management operation performed on the memory blocks of the memory device 150. Herein, in the memory system in accordance with an embodiment of the present invention, since the command executions corresponding to a plurality of commands received from the host 102 and the swap operation and the copy operation performed on the memory device 150 in consideration of the parameters corresponding to the command executions will be described in detail later with reference to FIGS. 5 to 9, overlapping descriptions will be omitted.

The processor 134 of the controller 130 may include a management unit (not illustrated) for performing a bad management operation of the memory device 150. The management unit may perform a bad block management operation of checking a bad block, in which a program fail occurs due to the characteristic of a NAND flash memory during a program operation, among the plurality of memory blocks 152 to 156 included in the memory device 150. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation performing with more reliability is needed.

FIG. 2 is a schematic diagram illustrating the memory device 150.

Referring to FIG. 2, the memory device 150 may include a plurality of memory blocks BLOCK0 to BLOCKN−1 and each of the blocks BLOCK0 to BLOCKN−1 may include a plurality of pages, for example, 2^{M} pages, the number of which may vary according to circuit design.

Also, memory cells included in the respective memory blocks BLOCK0 to BLOCKN−1 may be one or more of a single level cell (SLC) memory block storing 1-bit data or a multi-level cell (MLC) memory block storing 2-bit data. Hence, the memory device 150 may include SLC memory blocks or MLC memory blocks, depending on the number of bits which can be expressed or stored in each of the memory cells in the memory blocks. The SLC memory blocks may include a plurality of pages which are embodied by memory cells each storing one-bit data and may generally have high data computing performance and high durability. The MLC memory blocks may include a plurality of pages which are embodied by memory cells each storing multi-bit data (for example, 2 or more bits), and may generally have a larger data storage space than the SLC memory block, that is, higher integration density. In another embodiment, the memory device 150 may include a plurality of triple level cell (TLC) memory blocks. In yet another embodiment, the memory device 150 may include a plurality of quadruple level cell (QLC) memory blocks. The TCL memory blocks may include a plurality of pages which are embodied by memory cells each capable of storing 3-bit data. The QLC memory blocks may include a plurality of pages which are embodied by memory cells each capable of storing 4-bit data. Although the embodiment of the present invention exemplarily describes, for the sake of convenience in description, that the memory device 150 may be the nonvolatile memory, it may implemented by any one of a phase change random access memory (PCRAM), a resistive random access memory (RRAM(ReRAM)), a ferroelectrics random access memory (FRAM), and a spin transfer torque magnetic random access memory (STT-RAM(STT-MRAM)).

FIG. 3 is a circuit diagram illustrating an exemplary configuration of a memory cell array of a memory block 330 in the memory device 150. For example, the memory block 330 may correspond to any of the plurality of memory blocks 152 to 156 included in the memory device 150 of the memory system 110.

Referring to FIG. 3, the memory block 330 may include a plurality of cell strings 340 coupled to a plurality of corresponding bit lines BL0 to BLm−1. The cell string 340 of each column may include one or more drain select transistors DST and one or more source select transistors SST. Between the drain and source select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1.

Although FIG. 3 illustrates NAND flash memory cells, the present disclosure is not limited thereto. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply unit 310 which provides word line voltages including a program voltage, a read voltage, and a pass voltage to supply to the word lines according to an operation mode. The voltage generation operation of the voltage supply unit 310 may be controlled by a control circuit (not illustrated). Under the control of the control circuit, the voltage supply unit 310 may select one of the memory blocks (or sectors) of the memory cell array, select one of the word lines of the selected memory block, and provide the word line voltages to the selected word line and the unselected word lines as may be needed.

The memory device 150 may include a read/write circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

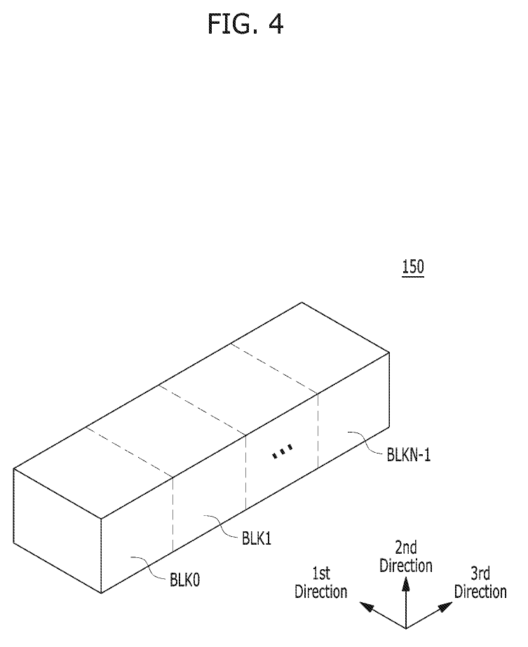

FIG. 4 is a schematic diagram illustrating an exemplary 3D structure of the memory device 150.

The memory device 150 may be embodied by a 2D or 3D memory device. Particularly, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1 each having a 3D structure (or vertical structure). FIGS. 5 to 8 are schematic diagrams illustrating a data processing operation when a plurality of command executions corresponding to a plurality of commands may be performed in a memory system in accordance with an embodiment of the present invention. In the embodiment of the present disclosure, the memory system 110 illustrated in FIG. 1 may receive a plurality of commands from the host and perform a plurality of command executions corresponding to the plurality of command. In particular, the memory system 110 may receive a plurality of write commands from the host 102 to perform a plurality of program operations corresponding to the write commands, may receive a plurality of read commands from the host 102 to perform a plurality of read operations corresponding to the read commands, may receive a plurality of erase commands from the host 102 to perform a plurality of erase operations corresponding to the erase commands or may receive successively a plurality of write commands and a plurality of read commands from the host 102 to perform a plurality of program operations and read operations corresponding to the write commands and the read commands.

Furthermore, in accordance with the embodiment of the present disclosure, after storing write data corresponding to a plurality of write commands received from the host 102 in the buffers/caches included in the memory 144 of the controller 130, the data stored in the buffers/caches may be programmed and stored in the plurality of memory blocks included in the memory device 150 to perform program operations. After generating and updating map data according to the program operations for the memory device 150, the updated map data may be stored in plurality of the memory blocks included in the memory device 150. That is, program operations corresponding to a plurality of write commands received from the host 102 may be performed.

Further, in the embodiment of the present disclosure, when a plurality of read commands are received from the host 102 for the data stored in the memory device 150, data corresponding to the read commands may be read from the memory device 150 by checking map data of the data corresponding to the read commands, and after storing the read data in the buffers/caches included in the memory 144 of the controller 130, the data stored in the buffers/caches may be provided to the host 102. That is, read operations corresponding to a plurality of read commands received from the host 102 may be performed.

In addition, in the embodiment of the present disclosure, when a plurality of erase commands are received from the host 102 for the memory blocks included in the memory device 150, memory blocks corresponding to the erase commands may be checked, data stored in the checked memory blocks may be erased, map data may be updated in correspondence to the erased data, and the updated map data may be stored in the plurality of memory blocks included in the memory device 150. That is, erase operations corresponding to a plurality of erase commands received from the host 102 may be performed.

While the controller 130 may perform a plurality of command executions in the memory system 110, it is to be noted that, as described above, the processor 134 included in the controller 130, e.g., the FTL, may perform data processing operation through, for example, a flash translation layer (FTL).

For example, in the embodiment of the present disclosure, the controller 130 may program and store user data and metadata corresponding to write commands received from the host 102 into certain memory blocks selected from the plurality of memory blocks included in the memory device 150, may read the user data and metadata corresponding to read commands received from the host 102 from the certain memory blocks selected from the plurality of memory blocks included in the memory device 150, and may provide the read data to the host 102, or may erase the user data and metadata corresponding to erase commands received from the host 102 from the certain memory blocks selected from the plurality of memory blocks included in the memory device 150.

The metadata may include first map data including a logical/physical (L2P: logical to physical) information (hereinafter, referred to as a ‘logical information’) and second map data including a physical/logical (P2L: physical to logical) information (hereinafter, referred to as a ‘physical information’), on the data stored in the memory blocks in correspondence to the program operation. Also, the metadata may include information on the command data corresponding to the command received from the host 102, information on the command execution corresponding to the command, information on the memory blocks of the memory device 150 for which the command execution is to be performed, and information on map data corresponding to the command execution. In other words, the metadata may include all information and data, except for the user data corresponding to the command received from the host 102.

That is, in the embodiment of the present disclosure, the controller 130 may perform command executions corresponding to a plurality of commands received from the host. For example, the controller 130 may perform program operations corresponding to a plurality of write commands when write commands are received from the host 102. At the time, the user data corresponding to the write commands may be written and stored in the memory blocks of the memory device 150, for example, empty memory blocks, open memory blocks or free memory blocks subject to an erase operation, among the memory blocks. Further, first map data including an L2P map table or an L2P map list and second map data including a P2L map table or a P2L map list may be written and stored in the empty memory blocks, open memory blocks, or free memory blocks among the memory blocks of the memory device 150. Logical information indicating mapping information between logical addresses and physical addresses for user data stored in the memory blocks may be recorded in the L2P map table or the L2P map list. Physical information indicating mapping information between physical addresses and logical addresses for the memory blocks storing the user data may be recorded in the P2L map table or the P2L map list.

Here, when receiving write commands from the host 102, the controller 130 may write and store user data corresponding to the write commands in memory blocks, and may store metadata including the first map data and second map data associated with the user data stored in the memory blocks, in memory blocks. In particular, as the data segments of the user data are stored in the memory blocks of the memory device 150, the controller 130 may generate and update the meta segments of the matadata including the L2P segments of the first map data and the P2L segments of the second map data, as the map segments of map data and may store the map segments in the memory blocks of the memory device 150. At this time, the controller 130 may update the map segments stored in the memory blocks of the memory device 150 by loading the map segments stored in the memory blocks onto the memory 144 of the controller 130.

Further, when a plurality of read commands are received from the host 102, the controller 130 may read the read data corresponding to the read commands, from the memory device 150, may store the read data in the buffers/caches included in the memory 144 of the controller 130, and then, provide the data stored in the buffers/caches to the host 102 to perform read operations corresponding to the plurality of read commands

Also, when a plurality of erase commands are received from the host 102, the controller 130 may check memory blocks of the memory device 150 corresponding to the erase commands, and then may perform erase operations for the memory blocks.

Hereinafter, detailed descriptions will be made with reference to FIGS. 5 to 8 for a data processing operation in the memory system in accordance with the embodiments.

Referring to FIG. 5, the controller 130 may perform command executions corresponding on a plurality of commands received from the host 102, for example, program operations corresponding to a plurality of write commands received from the host 102. At this time, the controller 130 may program and store user data pointed out by the write commands, in memory blocks 552, 554, 562, 564, 572, 574, 582, and 584 (hereinafter, referred to as ‘memory blocks 552 to 584’) of the memory device 150. With the program operation on the memory blocks 552 to 584, the controller 130 may generate and update metadata associated with the user data and may store the metadata in the memory blocks 552 to 584.

The controller 130 may generate and update first map data and second map data corresponding to information indicating that the user data have been stored in a plurality of pages included in the memory blocks 552 to 584. For example, the controller 130 may generate and update L2P segments indicating the logical segments of the first map data and P2L segments indicating the physical segments of the second map data, and then, may store the L2P segments and the P2L segments in the memory blocks 552 to 584.

For example, the controller 130 may cache and buffer the user data corresponding to the write commands received from the host 102, in a first buffer 510 included in the memory 144 of the controller 130. For example, the controller 130 may store data segments 512 of the user data in the first buffer 510 for buffering/caching data. Then, the controller 130 may store the data segments 512 stored in the first buffer 510, in the pages included in the memory blocks 552 to 584. When the data segments 512 of the user data corresponding to the write commands received from the host 102 are programmed and stored in the pages included in the memory blocks 552 to 584, the controller 130 may generate and update the first map data and the second map data, and may store the first map data and the second map data in a second buffer 520 included in the memory 144. In short, the controller 130 may store L2P segments 522 of the first map data associated with the user data and P2L segments 524 of the second map data associated with the user data, in the second buffer 520 for map buffering/caching. The L2P segments 522 of the first map data and the P2L segments 524 of the second map data or a map list for the L2P segments 522 of the first map data and a map list for the P2L segments 524 of the second map data may be stored in the second buffer 520 in the memory 144. Also, the controller 130 may store the L2P segments 522 of the first map data and the P2L segments 524 of the second map data of in the second buffer 520, in the pages included in the memory blocks 552 to 584.

Also, the controller 130 may perform command executions corresponding to a plurality of commands received from the host 102, for example, read operations corresponding to a plurality of read commands received from the host 102. At this time, the controller 130 may load the map segments of the map data associated with the user data corresponding to the read commands onto the second buffer 520. For example, the controller 130 may load L2P segments 522 of first map data and P2L segments 524 of second map data, onto the second buffer 520, and may check the L2P segments 522 and the P2L segments 524. Then, the controller 130 may read the user data associated with the first map data and the second map data from the pages of the memory blocks 552 to 584, may store data segments 512 of the read user data in the first buffer 510, and may provide the data segments 512 to the host 102.

Also, the controller 130 may perform command executions corresponding to a plurality of commands received from the host 102, for example, erase operations corresponding to a plurality of erase commands received from the host 102. At this time, the controller 130 may check memory blocks corresponding to the erase commands among the memory blocks 552 to 584, and may perform the erase operations on the checked memory blocks.

Still further, when a background operation of copying or swapping data stored in a plurality of memory blocks of the memory device 150, for example, a garbage collection operation or a wear-leveling operation, is performed, the controller 130 may store data segments 512 of user data into the first buffer 510, may load the map segments 522 and 524 of the map data associated with the user data onto the second buffer 520, and may perform a garbage collection operation or a wear-leveling operation of the plurality of memory blocks of the memory device 150.

Referring to FIG. 6, the memory device 150 may include a plurality of memory dies, e.g., a memory die 0 610, a memory die 1 630, a memory die 2 650, and a memory die 3 670 (hereinafter, collectively referred to as ‘memory dies 610 to 670’). Each of the memory dies 610 to 670 may include a plurality of planes. For example, the memory die 0 610 may include a plane 0 612, a plane 1 616, a plane 2 620, and a plane 3 624. The memory die 1 630 may include a plane 0 632, a plane 1 636, a plane 2 640, and a plane 3 644. The memory die 2 650 may include a plane 0 652, a plane 1 656, a plane 2 660, and a plane 3 664. The memory die 3 670 may include a plane 0 672, a plane 1 676, a plane 2 680 and a plane 3 684. The respective planes 612, 616, 620, 624, 632, 636, 640, 644, 652, 656, 660, 664, 672, 676, 680, and 684 (hereinafter, referred to as ‘planes 612 to 684’) in the memory dies 610 to 670 may include a plurality of memory blocks 614, 618, 622, 626, 634, 638, 642, 646, 654, 658, 662, 666, 674, 678, 682, and 686 (hereinafter, referred to as ‘memory blocks 614 to 686’), for example, N number of blocks Block0, Block1, . . . , and BlockN−1, each including a plurality of pages, e.g., 2^{M} pages, as described above with reference to FIG. 2. Also, the memory device 150 may include a plurality of buffers corresponding to the respective memory dies 610 to 670. For example, a buffer 0 628 may correspond to the memory die 0 610, a buffer 1 648 may correspond to the memory die 1 630, a buffer 2 668 may correspond to the memory die 2 650, and a buffer 3 688 may correspond to the memory die 3 670.

When performing command executions corresponding to a plurality of commands received from the host 102, data corresponding to the command executions may be stored in the buffers 628, 648, 668, and 688 (hereinafter, referred to as ‘buffers 628 to 688’). For example, when program operations are performed, data corresponding to the program operations may be stored in the buffers 628 to 688, and then may be stored in the pages included in the memory blocks of the memory dies 610 to 670. When read operations are performed, data corresponding to the read operations may be read from the pages included in the memory blocks of the memory dies 610 to 670, may be stored in the buffers 628 to 688, and may be then provided to the host 102 through the controller 130.

In an the embodiment of the present disclosure, the buffers 628 to 688 may be separated from the respective corresponding memory dies 610 to 670. In another embodiment of the present disclosure, each of the buffers 628 to 688 may be correspondingly incorporated into the respective corresponding memory dies 610 to 670. In another embodiment of the present disclosure, the buffers 628 to 688 may correspond to the respective planes 612 to 684 or the respective memory blocks 614 to 686 in the respective memory dies 610 to 670. Further, in an embodiment of the present disclosure, the buffers 628 to 688 included in the memory device 150 may correspond to the plurality of page buffers 322 to 326 included in the memory device 150 as described above with reference to FIG. 3. In another embodiment of the present disclosure, the buffers 628 to 688 may correspond to a plurality of caches or a plurality of registers included in the memory device 150.

Also, the plurality of memory blocks of the memory device 150 may be grouped into a plurality of super memory blocks, and a plurality of command executions may be performed on the plurality of super memory blocks. Herein, each of the plurality super memory blocks may include a plurality of memory blocks. For example, each of the plurality of super memory blocks may include a plurality of memory blocks included in both a first group of memory blocks and a second group of memory blocks. When the first group of memory blocks is included in a first plane of a first memory die, the second group of memory blocks may be included in the first plane of the first memory die, may be included in a second plane of the first memory die, or may be included in planes of a second memory die.

In the memory system in accordance with the embodiment of the present disclosure, when the controller performs command executions corresponding to a plurality of commands received from the host 102, e.g., program operations, read operations, and erase operations, on a plurality of memory blocks included in the memory device 150, the controller 130 may perform a copy operation or a swap operation on the memory device 150 in consideration of parameters for the memory device 150 according to the command executions, and as a result, improve the operation reliability and use efficiency of the memory device 150.

Herein, when the controller 130 performs program operations corresponding to the write commands received from the host 102 on the memory blocks included in the memory device 150, the controller 130 may program and store the data corresponding to the write commands received from the host 102 into pages included in the memory blocks of the memory device 150, and also when the write commands are received from the host 102 for the data stored in the pages of the memory blocks, the controller 130 may program and store the data in pages of the memory device 150. Herein, the user data which were previously stored in the pages of the memory blocks may become invalid data, and the pages with the user data previously stored in the memory blocks may become invalid pages. Therefore, the controller 130 may perform a copy operation on the memory blocks of the memory device 150 to maximize the use efficiency of the memory device 150 including the invalid pages. For example, the controller 130 may perform a garbage collection operation. In particular, the controller 130 may perform a copy operation, i.e., a garbage collection operation, in consideration of parameters for the memory blocks of the memory device 150, e.g., valid page counts (VPC) of the memory blocks, corresponding to the program operations.

When the controller 130 performs erase operations corresponding to a plurality of erase commands received from the host 102 on the memory blocks included the memory device 150, each of the memory blocks included in the memory device 150 may have a erase count limit so that the erase operations corresponding to the erase commands may be performed within the erase count limit. Herein, when the controller 130 performs the erase operations on particular memory blocks more than the erase count limit, the particular memory blocks may be treated as bad blocks, which may no longer be used. Therefore, the controller 130 may perform a swap operation, e.g., a wear-leveling operation, on the memory device 150 in consideration of the parameters of the memory blocks of the memory device 150 to secure operation reliability for the memory blocks of the memory device 150 from the erase operations.

Also, when the controller 130 repeatedly performs read operations corresponding to a plurality of read commands received from the host 102 on the memory blocks included in the memory device 150, for instance, on particular memory blocks, a read disturbance may occur in the particular memory blocks according to the repeated executions of the read operations. Therefore, the controller 130 may perform a copy operation, i.e., a read reclaim operation, on the memory device 150 in consideration of the parameters of the memory blocks of the memory device 150, e.g., read counts of the memory blocks, to prevent the memory blocks of the memory device 150 from losing data due to the read disturbance according to the read operations.

Also, when the controller 130 performs a plurality of command executions corresponding to a plurality of commands received from the host 102 on the memory blocks included in the memory device 150, the command executions may be performed on the memory blocks with a deteriorated operation reliability. In particular, the controller 130 may perform a bad block management operation for treating the particular memory blocks as bad blocks in consideration of the parameters for the memory blocks included in the memory device 150, e.g., error counts or failure counts for of the command operations in the memory blocks.

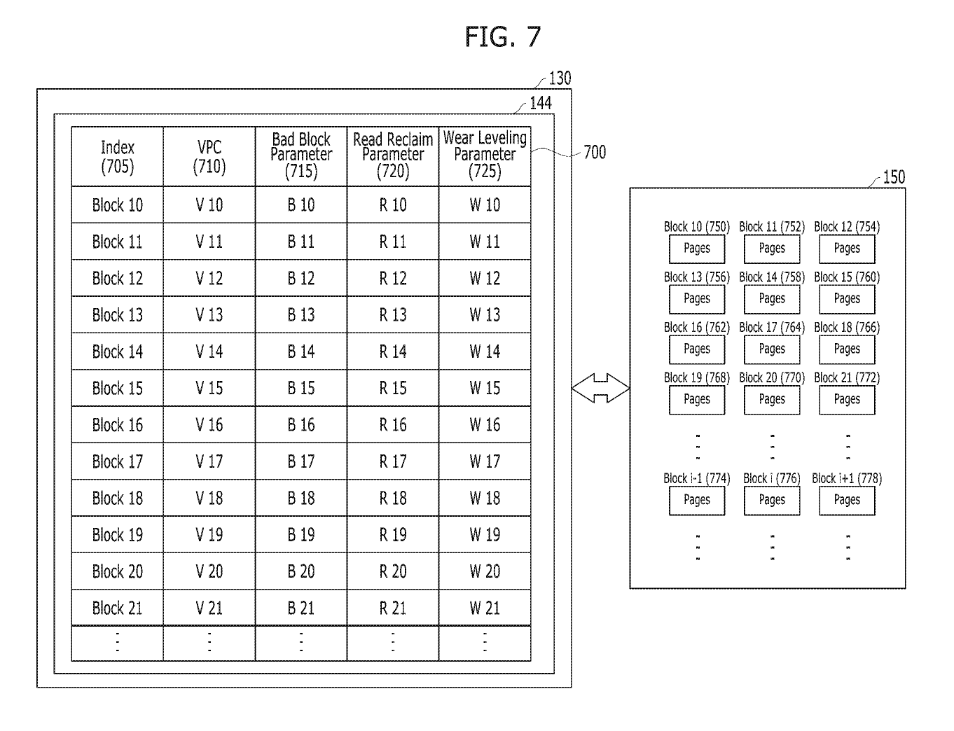

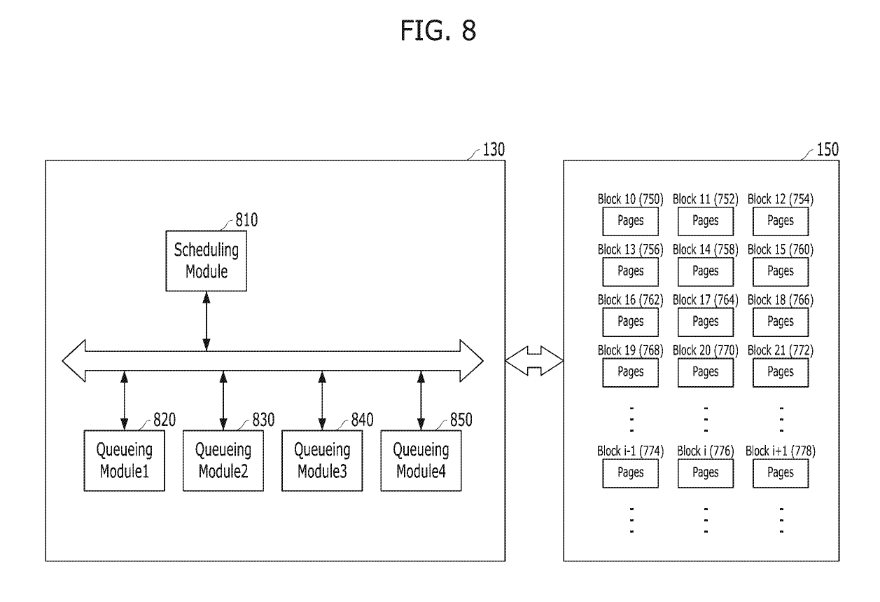

Particularly, in the memory system in accordance with the embodiment of the present disclosure, the controller 130 may perform a copy operation, i.e., a garbage collection operation, on the memory device 150 in consideration of the parameters for the memory blocks included in the memory device 150. The parameters for the memory blocks may include, e.g., the VPC of the memory blocks, the wear-leveling parameters for the memory blocks corresponding to a swap operation, i.e., a wear-leveling operation, in the memory device 150, the read reclaim parameters for memory blocks corresponding to a copy operation, i.e., a read reclaim operation, in the memory device 150, and the bad block parameters for memory blocks corresponding to an operation of processing bad blocks, i.e., a bad block management operation, in the memory device 150. Described hereafter is an operation of checking the parameters for the memory blocks included in the memory device 150 according to the executions of the corresponding commands and performing a bad block management operation, a swap operation, and a copy operation in the memory blocks of the memory device 150 on the memory system in consideration of the checked parameters with reference to FIGS. 7 to 8.

Referring to FIG. 7, when the controller 130 receives a plurality of commands, e.g., a plurality of write commands, a plurality of read commands, and a plurality of erase commands, from the host 102, it may perform the command executions corresponding to the commands received from the host 102, e.g., program operations, read operations, and erase operations, on a plurality of memory blocks included in the memory device 150. The controller 130 then may check the parameters for the memory blocks of the memory device 150 according to the command executions performed on the memory blocks of the memory device 150, manage the checked parameters, and also perform a swap operation such as a wear-leveling operation, a copy operation such as a garbage collection operation or a read reclaim operation, and a bad block management operation on the memory blocks of the memory device 150 in consideration of the parameters. Also, the controller 130 may perform the copy operation on the memory blocks of the memory device 150, e.g., the garbage collection operation, in consideration of the parameters corresponding to the swap operation such as the wear-leveling operation, the copy operation such as the read reclaim operation, and the bad block management operation performed on the memory blocks of the memory device 150.

In particular, the controller 130 may perform the command executions corresponding to the commands received from the host 102 on the memory blocks included in the memory device 150. The memory blocks may include a memory block 10 750, a memory block 11 752, a memory block 12 754, a memory block 13 756, a memory block 14 758, a memory block 15 760, a memory block 16 762, a memory block 17 764, a memory block 18 766, a memory block 19 768, a memory block 20 770, and a memory block 21 772 (hereinafter, collectively referred to as ‘memory blocks 750 to 772’). The controller 130 then may check parameters for the memory blocks 750 to 772 according to the command operations performed on the memory blocks 750 to 772. The controller 130 may manage the checked parameters, and particularly, register and manage the parameters for the memory blocks 750 to 772 at a parameter table 700, according to their indices 705. Herein, the parameter table 700 may become metadata for the memory device 150, and accordingly, the parameter table 700 may be stored in the memory 144 of the controller 130, particularly, in a second buffer 520 included in the memory 144 of the controller 130, and also stored in the memory device 150.

For example, when the controller 130 receives a plurality of write commands from the host 102, the controller 130 may store the data corresponding to the write commands in a plurality of pages included in the memory blocks 750 to 772. Further, when the controller 130 receives write commands from the host 102 for the data stored in the pages of the memory blocks 750 to 772, the controller 130 may read the data stored in the pages of the memory blocks 750 to 772 to write the read data into other pages. When the controller 130 stores the data corresponding to the write commands received from the host 102 in the pages of the memory blocks 750 to 772, in other words, when the controller 130 performs the program operation corresponding to the write commands on the memory blocks 750 to 772, invalid pages may be generated in the memory blocks 750 to 772 due to the program operations.

Herein, the controller 130 may check the parameters for the memory blocks 750 to 772 of the memory device 150, e.g., the valid page counts (VPC) 710 of the memory blocks 750 to 772. The controller 130 then may register the parameters corresponding to the program operations performed on the memory blocks 750 to 772, e.g., the VPC 710, at the parameter table 700 separately for each of the memory blocks 750 to 772. In short, when the controller 130 performs the program operations corresponding to the write commands received from the host 102 on the memory blocks 750 to 772, the controller 130 may check the VPC 710 for each of the memory blocks 750 to 772, and register the VPC 710 at the parameter table 700, according to their indices 705.

Also, the controller 130 may perform read operations corresponding to a plurality of read commands received from the host 102 on the memory blocks 750 to 772 of the memory device 150. Particularly, since read disturbance may occur in the memory blocks 750 to 772 according to the repeated executions of the read operations on the memory blocks 750 to 772, the controller 130 may perform a copy operation, i.e., a read reclaim operation, on the memory blocks 750 to 772 in consideration of the parameters of the memory blocks 750 to 772, e.g., read counts. The controller 130 may check the read reclaim parameters 720 for the memory blocks 750 to 772 of the memory device 150, e.g., read reclaim counts, according to the read reclaim operations performed on the memory blocks 750 to 772 of the memory device 150, and registers the read reclaim counts at the parameter table 700, according to their indices 705.

Also, when the controller 130 receives a plurality of erase commands from the host 102, the controller 130 may erase the data stored in the memory blocks 750 to 772 corresponding to the erase commands, that is, perform erase operations corresponding to the erase commands on the memory blocks 750 to 772. Herein, the controller 130 may check the parameters corresponding to the erase operations performed on the memory blocks 750 to 772, e.g., erase counts, for each of the memory blocks 750 to 772. When the erase counts for the memory blocks 750 to 772 exceeds a threshold erase count, in other words, when the erase counts for the memory blocks 750 to 772 exceeds an erase count limit, the memory blocks may be treated as bad blocks. Therefore, the controller 130 may perform a swap operation on the memory blocks 750 to 772, e.g., a wear-leveling operation, in consideration of the parameters for the memory blocks 750 to 772, e.g., the erase counts of the memory blocks 750 to 772. Also, the controller 130 may check wear-leveling parameters 725 for the memory blocks 750 to 772 of the memory device 150, e.g., the wear-leveling counts, according to the wear-leveling operations performed on the memory blocks 750 to 772 of the memory device 150, and register the wear-leveling parameters 725 at the parameter table 700, according to their indices 705.

Also, as described above, the controller 130 may perform the command executions corresponding to a plurality of commands received from the host 102 on the memory blocks 750 to 772 of the memory device 150. Particularly, since the operation reliability in the memory blocks 750 to 772 can be deteriorated depending on the command executions performed on the memory blocks 750 to 772, the controller 130 may check the parameters for the memory blocks 750 to 772, e.g., error counts or failure counts for the command executions performed on the memory blocks 750 to 772. The controller 130 may perform a bad block management operation for treating some memory blocks among the memory blocks 750 to 772 as bad blocks in consideration of the parameters for the memory blocks 750 to 772, e.g., error counts or failure counts. Also, the controller 130 may check bad block parameters for the memory blocks 750 to 772 of the memory device 150, e.g., bad block counts to register the bad block parameters 715 at the parameter table 700, according to their indices 705, in response to the bad block management operation performed on the memory blocks 750 to 772 of the memory device 150.

Also, the controller 130 may perform a copy operation, i.e., a garbage collection operation, on the memory blocks 750 to 772 of the memory device 150 in consideration of the parameters 710, 715, 720 and 725 of the memory blocks 750 to 772 registered at the parameter table 700. Herein, the controller 130 may set a trigger threshold value for performing a garbage collection operation on the memory blocks 750 to 772 of the memory device 150, and perform the garbage collection operation in consideration of the relationship between the parameters 710, 715, 720 and 725 of the memory blocks 750 to 772 registered at the parameter table 700, particularly, the VPC 710 of the memory blocks 750 to 772, and the trigger threshold value.

For example, the controller 130 may select memory blocks having a VPC 710 smaller than the trigger threshold value as source memory blocks or victim memory blocks among the memory blocks 750 to 772 of the memory device 150. The controller 130 may read valid data stored in the valid pages of the source memory blocks or the victim memory blocks to store the read valid data in target memory blocks, e.g., a memory block i−1 774, a memory block i 776, and a memory block i+1 778. Herein, empty memory blocks, open memory blocks, or free memory blocks among the memory blocks included in the memory device 150 may be selected as the target memory blocks.

Also, the controller 130 may set a threshold value for triggering a garbage collection operation to be performed, that is, a trigger threshold value, to perform a copy operation, i.e., a garbage collection operation, on the memory blocks 750 to 772 of the memory device 150. For example, the controller 130 may set an arbitrary threshold value as the trigger threshold value in consideration of the parameters 710, 715, 720 and 725 of the memory blocks 750 to 772 registered at the parameter table 700, or set the trigger threshold value to detect a distribution degree of valid pages in each of the memory blocks 750 to 772.

Herein, the controller 130 may set the trigger threshold value to detect the distribution degree of the valid pages in the memory blocks 750 to 772 based on the parameters 710, 715, 720 and 725 of the memory blocks 750 to 772 registered at the parameter table 700. For example, the controller 130 may set the trigger threshold value to determine whether the distribution of the valid pages is a locality distribution or uniformity distribution, based on the VPC 710 of the memory blocks 750 to 772. The locality may indicate that valid pages are weighted in favor of particular memory blocks and the uniformity distribution may indicate that valid pages are evenly distributed over the memory blocks. Herein, the controller 130 may set the trigger threshold value. The VPC 710 of the memory blocks 750 to 772 may be compared to the trigger threshold value. The controller 130 may trigger a garbage collection operation for the memory blocks for which VPC is smaller than the trigger threshold value, that is, the memory blocks having a uniformity distribution of valid pages so that the memory blocks having a uniformity distribution may be selected as source memory blocks or victim memory blocks. Also, the controller 130 may set a trigger threshold value to compare the VPC 710 of the memory blocks 750 to 772 to the trigger threshold value. The controller 130 may skip a garbage collection operation for the memory blocks whose VPC is greater than the trigger threshold value, that is, the memory blocks having a locality distribution of valid pages, so that the memory blocks having a locality distribution may be not selected as source memory blocks or victim memory blocks.

Also, the controller 130 may detect the number of the memory blocks included in the memory device 150 and the number of the pages included in each of the memory blocks based on the parameters 710, 715, 720 and 725 of the memory blocks 750 to 772 registered at the parameter table 700, particularly, the VPC 710, and determine the trigger threshold value based on the number of the memory blocks included in the memory device 150 and the number of the pages included in each of the memory blocks. For example, the controller 130 may detect the required number of target memory blocks, the number of target memory blocks on which a program operation is not performed, and the number of pages included in each of the memory blocks, particularly, the number of pages included in the target memory blocks through the garbage collection operation performed on the memory device 150 to determine the trigger threshold value based on the number of the target memory blocks and the number of the pages. Herein, the number of the target memory blocks may be the total number of the target memory blocks required to perform program operations on the memory device 150.

To summarize, the controller 130 may set the trigger threshold value for the memory blocks 750 to 772 of the memory device 150, compare the parameters 710, 715, 720 and 725 of the memory blocks 750 to 772 registered at the parameter table 700, particularly, the VPC 710, to the trigger threshold value, and determine the memory blocks on which a garbage collection operation is triggered to be performed and the memory blocks where a garbage collection operation is skipped among the memory blocks 750 to 772 based on the comparison result. Herein, as described earlier, the controller 130 may select the memory blocks on which a garbage collection operation is triggered to be performed, as source memory blocks or victim memory blocks among the memory blocks 750 to 772, and read the valid data stored in the valid pages of the source memory blocks or the victim memory blocks to store into the target memory blocks, e.g., the memory block i−1 774, the memory block i 776, and the memory block i+1 778.

Also, the controller 130 may compare the parameters 710, 715, 720 and 725 of the memory blocks 750 to 772 registered at the parameter table 700, particularly, the bad block parameters 715, the read reclaim parameters 720, or the wear-leveling parameters 725, with a state threshold value to perform a garbage collection operation. Herein, the controller 130 may set the state threshold value for performing the garbage collection operation on the memory blocks 750 to 772 of the memory device 150. As described earlier, the controller 130 may set the state threshold value in consideration of operation reliability of the memory device 150 according to the command executions, the copy operation, the swap operation, and the bad block management operation performed on the memory device 150.

For example, the controller 130 may compare the bad block parameters 715, the read reclaim parameters 720, or the wear-leveling parameters 725 of the memory blocks 750 to 772 of the memory device 150 to the state threshold value, and select memory blocks for which bad block parameters 715 or read reclaim parameters 720 are smaller than the state threshold value as candidate memory blocks. The controller 130 then may check the parameters for the candidate memory blocks registered at the parameter table 700, particularly, the VPC 710, select the memory blocks having the smallest VPC among the candidate memory blocks as source memory blocks or victim memory blocks, and read the valid data stored in the valid pages of the source memory blocks or the victim memory blocks to store into the target memory blocks, e.g., the memory block i−1 774, the memory block i 776, and the memory block i+1 778.

Herein, as described above, the controller 130 may check the memory blocks for skipping a garbage collection operation from the memory blocks 750 to 772 of the memory device 150 based on the VPC 710 and the trigger threshold value, and compare the bad block parameters 715, the read reclaim parameters 720, or the wear-leveling parameters 725 of the memory blocks for skipping a garbage collection operation, which are registered at the parameter table 700, to the state threshold value. The controller 130 may select candidate memory blocks from the memory blocks where a garbage collection operation is skipped, also select memory blocks having the smallest VPC among the candidate memory blocks as the source memory blocks or victim memory blocks, and read the valid data stored in the valid pages of the source memory blocks or the victim memory blocks to store into the target memory blocks, e.g., the memory block i−1 774, the memory block i 776, and the memory block i+1 778. Herein, the controller 130 may especially skip the garbage collection operation for the other memory blocks that are not selected as the candidate memory blocks among the memory blocks where a garbage collection operation is skipped.

Also, after the controller 130 reads the valid data stored in the valid pages of the source memory blocks or the victim memory blocks to store into the target memory blocks, e.g., the memory block i−1 774, the memory block i 776, and the memory block i+1 778, the controller 130 may perform an erase operation on the source memory blocks or the victim memory blocks. As a result, the source memory blocks or the victim memory blocks may become empty memory blocks, open memory blocks, or free memory blocks. Hereafter, how the controller 130 performs the copy operation, the swap operation, and the bad block management operation in consideration of the parameters of the memory blocks 750 to 772 registered in the parameter table 700 in the memory system in accordance with the embodiment of the present invention will be described in more detail with reference to FIG. 8.

Referring to FIG. 8, as described earlier, the controller 130 may schedule queues in a scheduling module 810 of the memory 144 in the controller 130 to perform the copy operation, the swap operation, and the bad block management operation in consideration of the parameters of the memory blocks 750 to 772 registered at the parameter table 700, and allocate queuing modules 820, 830, 840 and 850 (hereinafter, referred to as ‘queuing modules 820 to 850’) to the memory 144 of the controller 130.

Herein, the scheduling module 810 may schedule the queues using the processor 134 of the controller 130, particularly, the FTL. Also, when the controller 130 performs the copy operation, the swap operation, and the bad block management operation on the memory blocks 750 to 772 of the memory device 150, the queuing modules 820 to 850 may be the regions of the memory 144 for storing data corresponding to the copy operation, the swap operation, and the bad block management operation. For example, the queuing modules 820 to 850 may be buffers or caches included in the memory 144 of the controller 130. Also, although it is described in this embodiment of the present disclosure that the four queuing modules 820 to 850 are allocated to the memory 144 of the controller 130 for the sake of convenience in description, the priority of the copy operation, the swap operation, and the bad block management operation may be determined based on the types of the copy operation, the swap operation, and the bad block management operation; the queues in the memory 144 of the controller 130 may be scheduled separately for each type of the copy operation, the swap operation, and the bad block management operation; and a plurality of queuing modules may be allocated to store the data based on each type of the copy operation, the swap operation, and the bad block management operation.

As described earlier, when a copy operation, e.g., a garbage collection operation, is performed on the memory blocks 750 to 772 in consideration of the parameters of the memory blocks 750 to 772 of the memory device 150, the first queuing module 820 may store data corresponding to the garbage collection operation. Particularly, as described earlier, when the controller 130 performs the garbage collection operation in consideration of the parameters of the memory blocks 750 to 772 registered at the parameter table 700, the first queuing module 820 may store the data corresponding to the garbage collection operation.

Also, when a swap operation, e.g., a wear-leveling operation, is performed on the memory blocks 750 to 772 in consideration of the parameters of the memory blocks 750 to 772 of the memory device 150, e.g., the erase counts, the second queuing module 830 may store data corresponding to the wear-leveling operation. Herein, when the wear-leveling operation is performed on the memory blocks 750 to 772 through the second queuing module 830, the controller 130 may check the wear-leveling parameters 725, e.g., wear-leveling counts, for the memory blocks 750 to 772 of the memory device 150 according to the wear-leveling operation, and register the wear-leveling parameters 725 at the parameter table 700, according to their indices 705.

Also, when a copy operation, e.g., a read reclaim operation, is performed on the memory blocks 750 to 772 in consideration of the parameters of the memory blocks 750 to 772 of the memory device 150, e.g., the read counts, the third queuing module 840 may store data corresponding to the read reclaim operation. Herein, when the read reclaim operation is performed on the memory blocks 750 to 772 through the third queuing module 840, the controller 130 may detect the read reclaim parameters 720, e.g., the read reclaim counts, for the memory blocks 750 to 772 of the memory device 150 according to the read reclaim operation, and register the read reclaim parameters 720 at the parameter table 700, according to their indices 705.

Also, when a bad block management operation is performed on the memory blocks 750 to 772 in consideration of the parameters of the memory blocks 750 to 772 of the memory device 150, e.g., the error counts or failure counts for the command operations performed on the memory blocks 750 to 772, the fourth queuing module 850 may store data corresponding to the bad block management operation. Herein, when the bad block management operation is performed on the memory blocks 750 to 772 through the fourth queuing module 850, the controller 130 may check the bad block parameters 715, e.g., the bad block counts, for the memory blocks 750 to 772 of the memory device 150 according to the bad block management operation, and register the bad block parameters 715 at the parameter table 700, according to their indices 705.

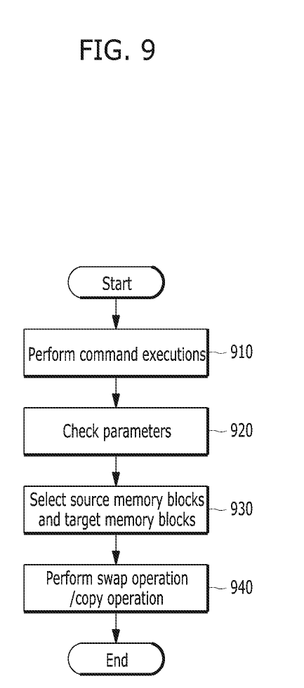

In the memory system in accordance with the embodiment of the present disclosure, when the controller 130 performs command executions corresponding to a plurality of commands received from the host 102, the controller 130 may check the parameters for the memory blocks of the memory device 150, and perform a copy operation e.g., a garbage collection operation or a read reclaim operation; a swap operation, e.g., a wear-leveling operation; and a bad block management operation on the memory blocks of the memory device 150 in consideration of the parameters of the memory blocks, and perform a copy operation, e.g., a garbage collection operation, on the memory blocks of the memory device 150 in consideration of the parameters of the memory blocks corresponding to the read reclaim operation, the wear-leveling operation, and the bad block management operation. Particularly, the controller 130 may improve the use efficiency of the memory device 150 by triggering or skipping the garbage collection operation performed on the memory blocks of the memory device 150 in consideration of the parameters of the memory blocks of the memory device 150. Hereafter, an operation of processing data in the memory system in accordance with the embodiment of the present invention will be described in detail with reference to FIG. 9.

FIG. 9 is a schematic flowchart describing a data processing operation in the memory system 110 in accordance with an embodiment of the present invention.

Referring to FIG. 9, the memory system 110 may receive a plurality of commands from the host 102 in step S910, and perform command executions corresponding to the commands received from the host 102.

In step S920, the memory system 110 may check the parameters for the memory blocks of the memory device 150 according to the command executions. In step S930, the memory system 110 may select source memory blocks and target memory blocks among the memory blocks in consideration of the parameters of the memory blocks.

Subsequently, in step S940, the memory system 110 may perform a swap operation, such as a wear-leveling operation, and a copy operation such as a garbage collection operation or a read reclaim operation, on the source memory blocks and the target memory blocks selected from the memory blocks. Herein, as described above, the memory system may perform the command executions on the memory blocks of the memory device 150; perform a swap operation, a copy operation, and a bad block management operation on the memory blocks according to the command executions; and perform a bad block management operation, a swap operation, e.g., a wear-leveling operation, and a garbage collection operation in consideration of the parameters of the memory blocks corresponding to a copy operation, e.g., a read reclaim operation.

Herein, since performing command executions corresponding to the commands received from the host 102; performing a copy operation, a swap operation, and a bad block management operation; and performing a copy operation, particularly, a garbage collection operation, in consideration of the parameters of the memory blocks corresponding to the copy operation, the swap operation, and the bad block management operation are described above in detail with reference to FIGS. 5 to 8, overlapping descriptions will be omitted herein.

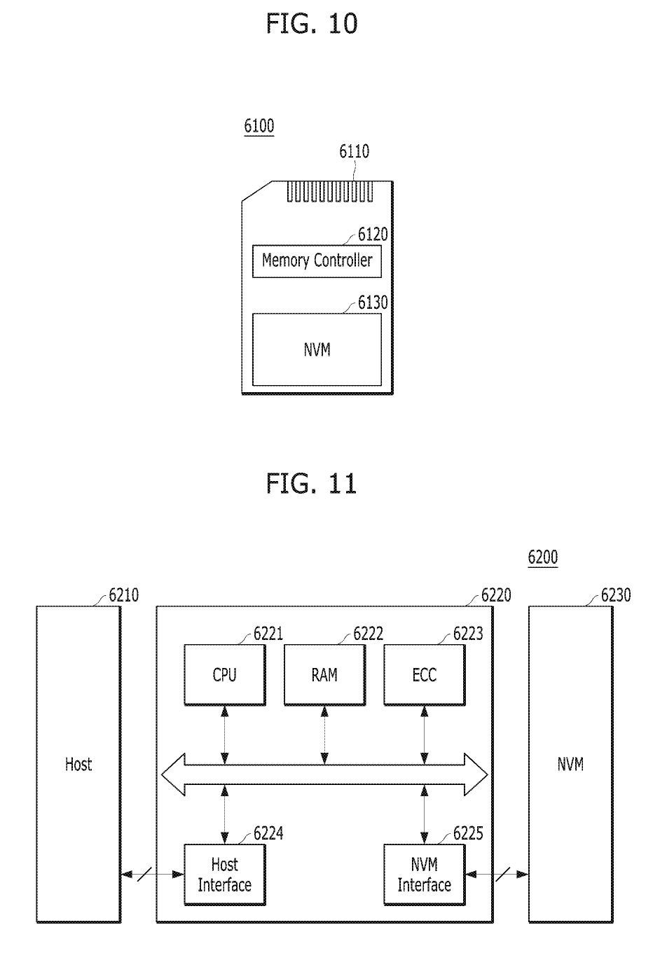

Hereafter, various data processing systems and electronic devices to which the memory system 110 including the memory device 150 and the controller 130, as described above with reference to FIGS. 1 to 9, in accordance with the embodiment of the present disclosure will be described in detail with reference to FIGS. 10 to 18.

FIG. 10 is a diagram schematically illustrating another example of the data processing system including the memory system in accordance with the present embodiment. FIG. 10 schematically illustrates a memory card system to which the memory system in accordance with the present embodiment is applied.

Referring to FIG. 10, the memory card system 6100 may include a memory controller 6120, a memory device 6130 and a connector 6110.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIGS. 1 to 8, and the memory device 6130 may correspond to the memory device 150 of the memory system 110 described with reference to FIGS. 1 to 8.

Thus, the memory controller 6120 may include a RAM, a processing unit, a host interface, a memory interface and an error correction unit. The memory controller 130 may further include the elements shown in FIG. 5, 7, or 8.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 5, 7, or 8.

The memory controller 6120 and the memory device 6130 may be integrated into a single semiconductor device. For example, the memory controller 6120 and the memory device 6130 may construct a solid-state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

FIG. 11 is a diagram schematically illustrating another example of the data processing system including the memory system in accordance with the present embodiment.

Referring to FIG. 11, the data processing system 6200 may include a memory device 6230 having one or more nonvolatile memories and a memory controller 6220 for controlling the memory device 6230. The data processing system 6200 illustrated in FIG. 11 may serve as a storage medium such as a memory card (CF, SD, micro-SD or the like) or USB device, as described with reference to FIGS. 1 and 5. The memory device 6230 may correspond to the memory device 150 in the memory system 110 illustrated in FIGS. 1 and 5, and the memory controller 6220 may correspond to the controller 130 in the memory system 110 illustrated in FIG. 1.

The memory controller 6220 may control a read, write or erase operation on the memory device 6230 in response to a request of the host 6210, and the memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with the present embodiment may be applied to wired/wireless electronic devices or particularly a mobile electronic device.

FIG. 12 is a diagram schematically illustrating another example of the data processing system including the memory system in accordance with the present embodiment. FIG. 12 schematically illustrates an SSD to which the memory system in accordance with the present embodiment is applied.

Referring to FIG. 12, the SSD 6300 may include a controller 6320 and a memory device 6340 including a plurality of nonvolatile memories. The controller 6320 may correspond to the controller 130 in the memory system 110 of FIGS. 1 to 8, and the memory device 6340 may correspond to the memory device 150 in the memory system of FIGS. 1 to 8.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. For convenience of description, FIG. 11 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIGS. 1 to 8 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

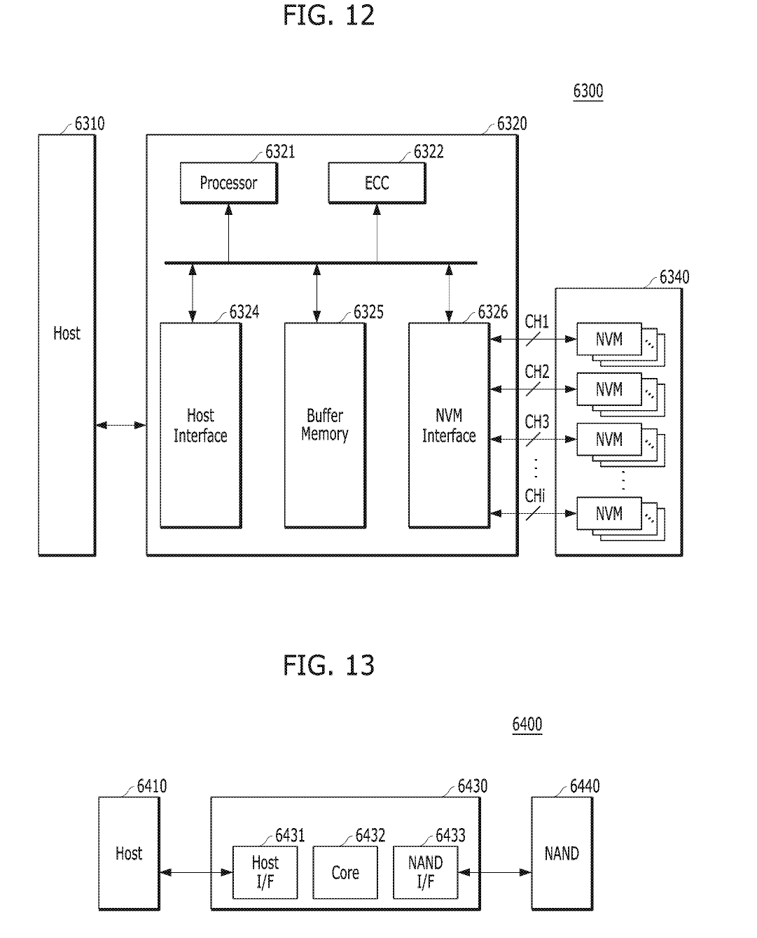

FIG. 13 is a diagram schematically illustrating another example of the data processing system including the memory system in accordance with the present embodiment. FIG. 13 schematically illustrates an embedded Multi-Media Card (eMMC) to which the memory system in accordance with the present embodiment is applied.

Referring to FIG. 13, the eMMC 6400 may include a controller 6430 and a memory device 6440 embodied by one or more NAND flash memories. The controller 6430 may correspond to the controller 130 in the memory system 110 of FIGS. 1 to 8, and the memory device 6440 may correspond to the memory device 150 in the memory system 110 of FIGS. 1 to 8.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

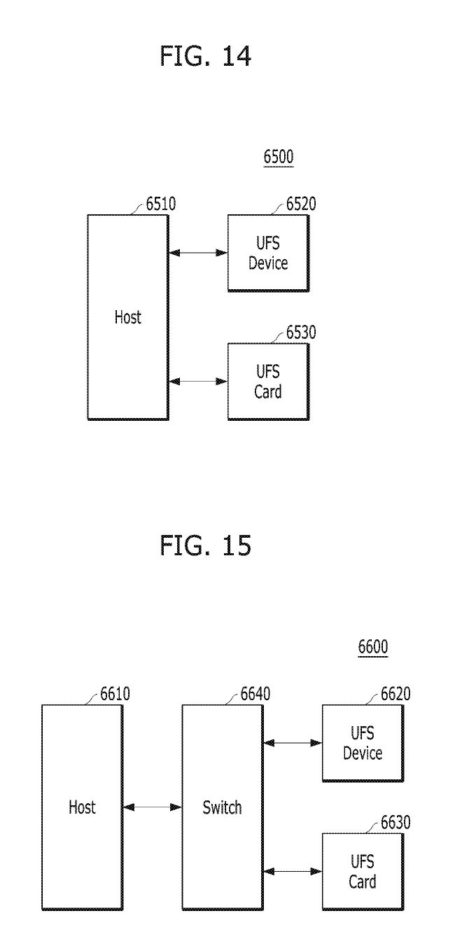

FIGS. 14 to 17 are diagrams schematically illustrating other examples of the data processing system including the memory system in accordance with the present embodiment. FIGS. 14 to 17 schematically illustrate UFS (Universal Flash Storage) systems to which the memory system in accordance with the present embodiment is applied.

Referring to FIGS. 14 to 17, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired/wireless electronic devices or particularly mobile electronic devices through UFS protocols, and the UFS devices 6520, 6620, 6720 and 6820 and the UFS cards 6530, 6630, 6730 and 6830 may be embodied by the memory system 110 illustrated in FIGS. 1 to 8. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 11 to 13, and the UFS cards 6530, 6630, 6730 and 6830 may be embodied in the form of the memory card system 6100 described with reference to FIG. 10.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, UFDs, MMC, SD, mini-SD, and micro-SD.

In the UFS system 6500 illustrated in FIG. 14, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

In the UFS system 6600 illustrated in FIG. 15, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

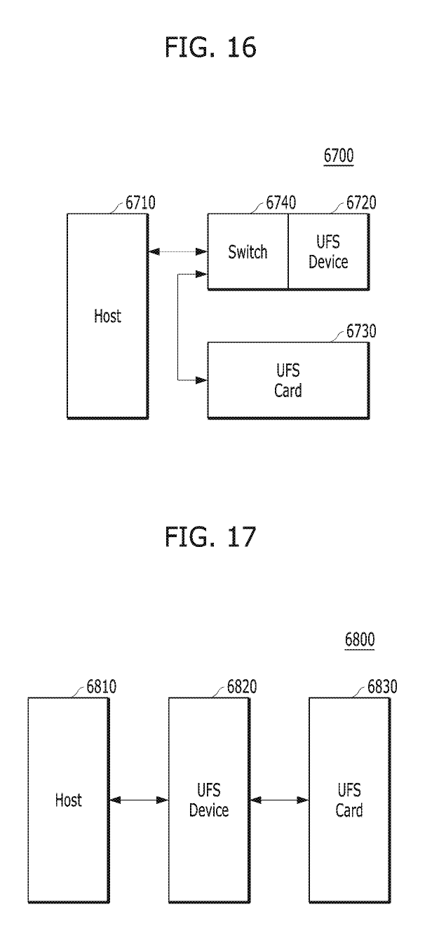

In the UFS system 6700 illustrated in FIG. 16, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 17, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

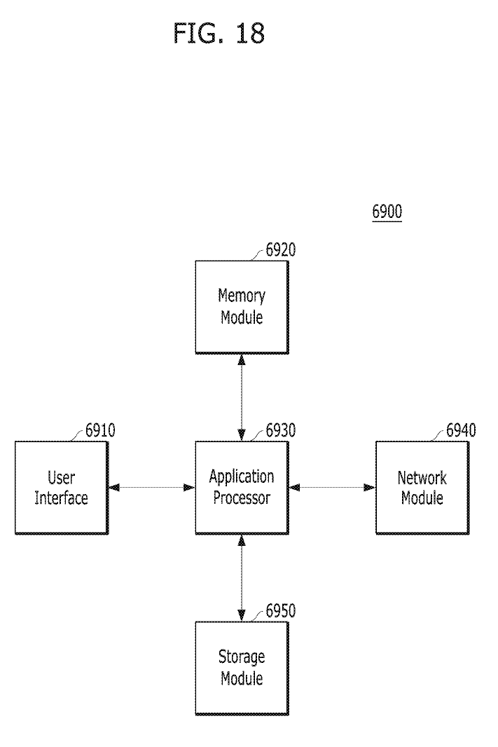

FIG. 18 is a diagram schematically illustrating another example of the data processing system including the memory system in accordance with an embodiment of the present invention. FIG. 18 is a diagram schematically illustrating a user system to which the memory system in accordance with the present embodiment is applied.

Referring to FIG. 18, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIGS. 1 to 8. Furthermore, the storage module 6950 may be embodied as an SSD, eMMC and UFS as described above with reference to FIGS. 12 to 17.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

The memory system and the operating method thereof according to the embodiments may minimize complexity and performance deterioration of the memory system and maximize use efficiency of a memory, thereby quickly and stably process date with respect to the memory device.

Although various embodiments have been described for illustrative purposes, it will be apparent to those skilled in the art that various changes and modifications may be made without departing from the spirit and scope of the invention as defined in the following claims.

What is claimed is:

1. A memory system, comprising:
a memory device that includes a plurality of memory blocks, each of which includes a plurality of pages that store data; and
a controller suitable for performing command executions corresponding to a plurality of commands received from a host on the memory blocks, checking first parameters for the memory blocks according to the command executions, selecting first memory blocks among the memory blocks based on the first parameters, performing a copy operation on the first memory blocks, checking second parameters for second memory blocks among the memory blocks, and selecting candidate memory blocks based on the second parameters.

2. The memory system of claim 1, wherein the controller set a first threshold value for the copy operation and selects the first memory blocks among the memory blocks by comparing the first parameters to the first threshold value.

3. The memory system of claim 2, wherein the controller detects a distribution degree of valid pages that are included in the memory blocks based on the first threshold value.

4. The memory system of claim 3, wherein the controller detects memory blocks having a locality distribution and memory blocks having a uniformity distribution among the memory blocks based on the first threshold value.

5. The memory system of claim 4, wherein the controller selects the memory blocks having the uniformity distribution as the first memory blocks and selects the memory blocks having the locality distribution as the second memory blocks.

6. The memory system of claim 5, wherein the first memory blocks are memory blocks for triggering the copy operation, and
the second memory blocks are memory blocks for skipping the copy operation.

7. The memory system of claim 2, wherein the controller sets the first threshold value based on the number of third memory blocks among the memory blocks, the number of the first memory blocks, and the number of pages included in the third memory blocks.

8. The memory system of claim 1, wherein the controller sets a second threshold value for at least one operation among a swap operation, the copy operation, and a bad block management operation on the second memory blocks, and selects the candidate memory blocks by comparing the second parameters to the second threshold value.

9. The memory system of claim 8, wherein the controller selects fourth memory blocks having a smallest first parameters among the candidate memory blocks, and performs the copy operation on the fourth memory blocks.

10. The memory system of claim 1, wherein the second parameters are determined according to at least one operation among a swap operation, the copy operation, and a bad block management operation based on the first parameters.

11. A method for operating a memory system, comprising:
receiving a plurality of commands from a host for a memory device that includes a plurality of memory blocks each of which includes a plurality of pages that store data;
performing command executions corresponding to the commands on the memory blocks;
checking first parameters for the memory blocks according to the command executions;
selecting first memory blocks among the memory blocks based on the first parameters;
performing a copy operation on the first memory blocks;
checking second parameters for second memory blocks among the memory blocks; and
selecting candidate memory blocks based on the second parameters.

12. The method of claim 11, wherein the selecting of the first memory blocks among the memory blocks based on the first parameters includes:
setting a first threshold value for the copy operation on the memory blocks; and
selecting the first memory blocks by comparing the first parameters to the first threshold value.

13. The method of claim 12, wherein the selecting of the first memory blocks among the memory blocks based on the first parameters further includes:
detecting a distribution degree of valid pages that are included in the memory blocks based on the first threshold value.

14. The method of claim 13, wherein in the detecting of the distribution degree of the valid pages,
memory blocks having a locality distribution and memory blocks having a uniformity distribution are detected among the memory blocks based on the first threshold value.

15. The method of claim 14, wherein the selecting of the first memory blocks among the memory blocks based on the first parameters further includes:
selecting the memory blocks having the uniformity distribution as the first memory blocks; and
selecting the memory blocks having the locality distribution as the second memory blocks.

16. The method of claim 15, wherein the first memory blocks are memory blocks for triggering the copy operation, and
the second memory blocks are memory blocks for skipping the copy operation.

17. The method of claim 12, wherein in the setting of the first threshold value for the copy operation on the memory blocks,
the first threshold value is set based on the number of third memory blocks among the memory blocks, the number of the first memory blocks, and the number of pages included in the third memory blocks.

18. The method of claim 11, wherein the selecting of the candidate memory blocks based on the second parameters includes:
setting a second threshold value for at least one operation among a swap operation, the copy operation, and a bad block management operation on the second memory blocks; and
selecting the candidate memory blocks by comparing the second parameters to the second threshold value.

19. The method of claim 18, wherein the selecting of the candidate memory blocks based on the second parameters further includes:
selecting fourth memory blocks having a smallest first parameters among the candidate memory blocks; and
performing the copy operation on the fourth memory blocks.

20. The method of claim 11, wherein the second parameters are determined according to at least one operation among a swap operation, the copy operation, and a bad block management operation based on the first parameters.
